(19) United States
(12) Patent Application Publication
(10) Pub. No.: US 2007/0256602 A1
(43) Pub. Date: Nov. 8, 2007

(54) Activated silicon-containing aluminum complex reactivator and transforming agent

(76) Inventor: Matthew Feller, Tenafly, NJ (US)

Correspondence Address: Matthew Feller, 2150 Center Ave., Fort Lee, NJ, 02024, US

(21) Appl. No.: 11/417,306

(22) Filed: May 3, 2006

(51) Int. Cl. C04B 18/06

(52) U.S. Cl. 106/705

(57) ABSTRACT

An activated silicon-containing aluminum complex reactivator and transforming agent containing minor amounts of halogen, silicon oxygen and hydrogen. The silicon being present in the amounts of at least trace and having a hexagonal structure; the ratio of oxygen to hydrogen being 16:18 and the process for making such complex comprises steps for treating substantially pure aluminum with acid, then with mercury, then with a halogen acid again to form a slurry.

### REFERENCE TO RELATED APPLICATIONS

This application is a continuation of application Ser No. 312,512 filed Oct. 19, 1981 now abandoned and reapplied.

This application is related to the U.S. patent Ser. No. 275,801 filed Jun. 22, 1981 for ACTIVATED SILICON-CONTAINING ALUMINUM COMPLEX AND METHOD OF PREPARATION THEREOF.

### SUMMARY OF THE INVENTION

The usefulness of the complex of the present invention will extend to transforming useless and ecologically problematic fly ash into high BTU hydrocarbon complex fuel.

Moreover, the subject of the complex is non-polluting, non-toxic, and safe environmentally, having no adverse impact of any kind in the atmosphere and water. It is noncorrosive.

In addition to its usefulness in making the complex, the slurry is also useful in the preparation of other products, such as the propellant (U.S. Pat. No. 795,115) and “fuel” (U.S. Pat. No. 810,103).

It is an object of the present invention to provide an activated silicon aluminum complex which is capable of releasing oxygen and hydrogen from an oxygen and hydrogen containing fluid.

Another object of the subject invention is to provide a unique slurry.

Another object of the subject invention is to provide a method for the preparation of the said silicon-aluminum complex including the preparation of the slurry.

Another object of this invention is to provide a method to apply the said slurry on fly ash rendering it and reactivated.

Still another object of the subject invention is to transform a certain percentage of the carbon containing fly ash into a highly flammable, industrially utilizable hydrocarbon fuel.

Still other objects will become apparent from the ensuing description and appended claims and drawings.

According to this invention, the activated aluminum complex consists essentially of aluminum and minor amounts of chlorine, activated hexagonally structured silicon, oxygen and hydrogen; the oxygen and hydrogen being present to atomic proportions of usually 16:18 or occasionally 14:16,18:20 or mixtures thereof and the sum of the said chlorine, silicon, hydrogen and oxygen atoms not expending more than about 5 percent by weight of the aluminum atoms of said complex.

The complex can be prepared by the following sequence of steps:
1) Contacting aluminum metal having a purity preferable on the order of at least about 99.94% by weight, but including at least trace amount of silicon, with a source of acid of a type and concentration which will removed and inhibit the formation of oxide thereon; simultaneously, or thereafter, contacting said aluminum with mercury or less preferable a source of mercury in an oxygen-containing atmosphere.
2) At least partly immersing said mercury contacted aluminum in an acidic solution at a temperature of between ambient and not more than about 40° C.,
3) Increasing the viscosity of the slurry up to between 12,000 cps preferably closer to 16,000 cps.
4) adjusting the pH of said slurry to 3.0±0.2.
5) Immersing in the said slurry a mercury coated aluminum bar.
6) Placing the said mercury coated aluminum reinforced slurry under an open container containing the fly ash.
7) Place an open container containing an activated aluminum-silicon slurry with a specific gravity between 1.012-1.017 on the top of the freely exposed fly ash.
8) Place the whole operation in a monitored closed region of ambient temperature and pressure.

### BRIEF DESCRIPTION OF THE DRAWINGS

For a better understanding of the invention, reference will be made to the accompanying drawings, wherein:

FIG 1) is a schematic sectional elevational view of one embodiment of stage 1 of the process of the present invention.

FIG. 2) is a schematic view similar to FIG. 1) showing another optional embodiment of stage 10 of the process of the present invention.

FIG. 3) is a schematic view similar to FIG 1) showing the formation of the slurry in the HCl bath in stage two of the process of the present invention. In this embodiment, the aluminum is disposed substantially equidistant from the sides and bottom of the vessel.

FIG. 4) is a depiction of the structure of the untreated inactive silicon found in nonactivated form in the aluminum.

FIG 5) is a depiction of the hexagonal structure of the silicon of the complex formed in the stages two and three of the process of the present invention, in the slurry.

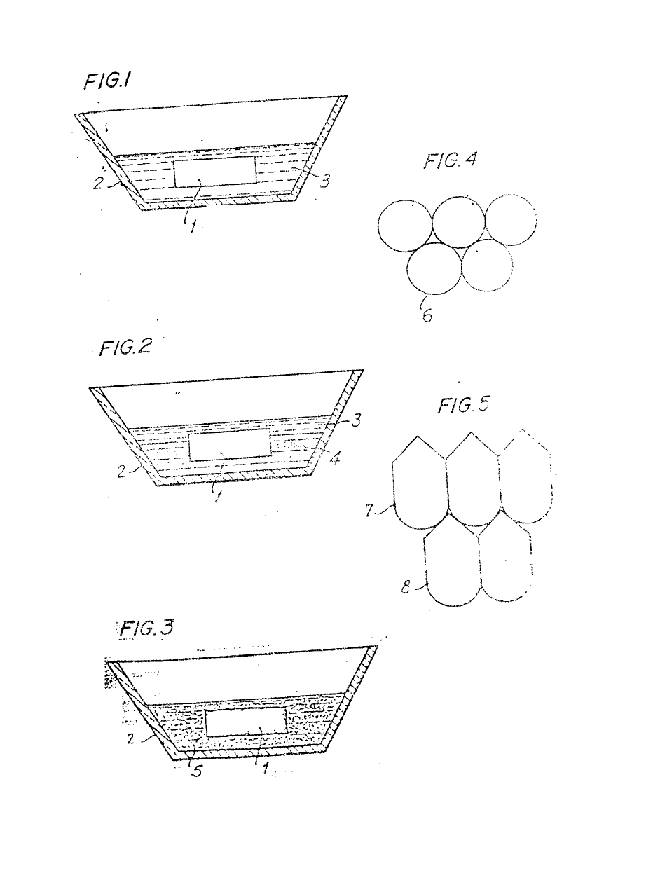

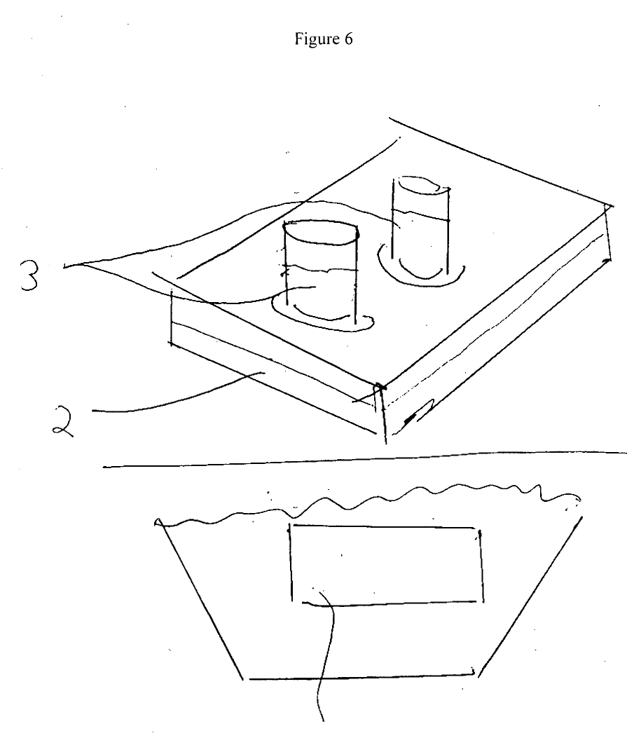

### DETAILED DESCRIPTION OF THE INVENTION

The activated-silicon containing aluminum complex of this invention can be conveniently prepared, utilizing a six stage process, although the process is not to be narrowly construed as being limited to such. The first stage, the preparation of a form of aluminum which can be termed “phase-one” can typically be carried out as follows:

Utilizing the apparatus of FIG. 1) an aluminum bar or rod (1) is placed as shown, in a vessel (2), the latter preferably of glass, and a thin layer of hydrochloric acid (3) is placed there slightly, covering the aluminum. IN this context the shape of aluminum is not narrowly critical. However a bar or rod shape is generally preferred. The purpose of the acid treatment is to inhibit the formation of oxide on the aluminum surface. HCl is usually the acid employed for this purpose.

It is important that the aluminum is substantially pure, on the order of but not limited, to about 99.94% pure and also contains amounts of silicon on the order of trade to about 60 to 150 ppm. As a practical matter, whether the aluminum is sufficiently pure can be empirically determined since, if there is an abrupt rise in temperature, this indicates oxide formation and the aluminum starting material was not substantially pure. Therefore, the purposes of this application the term “substantially pure aluminum denotes the degree of parity which is empirically determinable to be capable of being used in the process of this invention.

The aluminum is then contacted with mercury (or gallium or indium) preferably placing such in a bath of the same in a similar type apparatus; in the presence of any oxygen-gas-containing atmosphere, such as air. IN either of this preliminary steps the temperature is not narrowly critical, but should not be such as to encourage oxide formation and/or chlorine gas. Ambient temperature is satisfactory.

If desired, the acid and mercury contact can be made simultaneously as shown in FIG. 2). IN this figure the aluminum (1) is immersed in the acid bath (3) and the heavier mercury bath (4), the HCL forming a layer on the bath of mercury.

Whether the apparatus on FIGS. 1) or 2) or other suitable apparatus is used, the length of time of contact with the mercury can be minimal, on the order of between about fifteen and thirty seconds; longer contact, however is not detrimental. Within the context of this invention, the mercury acts only as a catalyst which effects a change in the aluminum structure. As indicated above, this changed structure is “phase one”.

The formation of ”phase two” is the second stage in the process of this invention. This stage involves the formation of a slurry comprising phase one immersed in an acidic solution containing halogen. Particularly preferred among the suitable halogen solutions is hydrochloric acid.

The slurry can be formed in a number of ways and the method thereof is not critical in and of itself. For example after contact with the mercury bath, the thus-treated aluminum rod or bar is then immersed in another vessel, containing a bath of HCl. The latter should have a normality of about 1 Normal to 2 Normal, but the actual range of concentration is empirical. When phase one, which is soluble in HCl to some extent, is immersed in the acid solution, a rather viscous slurry, white in color is formed. The slurry begins as a cloudy suspension and becomes increasingly dense. This is the consequence of particulate growth in and on the mercury-treated and activated aluminum rod or bar of phase one. This growth is shown in FIG. 3), wherein the thick slurry (5) is denoted as forming in the acid bath. As more and more particles form, the slurry becomes more and more viscous.

Depending on the size of the aluminum bar or the amount of the HCl present, the formation of the slurry can continue up to the entire consummation of the phase one aluminum material. However as a practical matter, the reaction will usually stop before the aluminum bar is consumed completely because the slurry will become too dense for further growth to occur. At this point, the thick slurry thus formed can be removed partly or completely; additional HCl is added and slurry formation continued. AS a practical matter, the viscosity of the slurry can be as low as 10,000 cps. For most efficient use such viscosity should be between about 12,000-16,000 cps.

The slurry is “phase two”. In the formation thereof pursuant to the preparation of the complex, the temperature is important, that is between ambient and not more than about 40 degrees centigrade, preferably between 22 degrees centigrade and 25 degrees. It should be noted that a sudden adverse rise in temperature of the reaction environment at this point could again mean that the aluminum starting material was not sufficiently pure.

Alternatively, though less desirably, the slurry can also be made in “situ” in the embodiment represented by FIG. 2). As shown in the FIG. 2), the aluminum bar or rod is covered by HCl bus is also partly submerged in the source of mercury. Optionally, the HCl need not to cover the aluminum after oxide formation thereon is prevented or inhibited. A portion of the aluminum can be exposed above the surface, IN either case. whether the HCl continues to cover the surface of the aluminum or not, a growth of some kind of complex occurs. This growth, itself, in this embodiment, is not the “phase two” slurry of this invention. The latter occurs in this “in situ” treatment, either when the particles of the “growth” “fall off” into the acidic portion of the HCl/Hg bath or optionally after removing the complex growth (whether in the aluminum surface-exposed to air, or in that covered by acid) and immersing the same in a separate HCl bath to form the slurry as herein before described. IN either case the sequence has been followed of treating an oxide-free aluminum with mercury to change the structure of the aluminum and to effect its activation and then contacting or continuing to contact said aluminum with HCl to cause the “phase two” slurry formation. In the slurry-forming step, it has been found useful in order to avoid undesirable heat from occurring, to position the aluminum bar or rod substantially equidistant from the sides and the bottom of the vessel, which is essentially the same as, or greater than the diameter of the bar or rod, a cylindrical rod shape being preferred. It is of course possible to inhibit formation of undesirable heat without the above indicated special relationships; in this event, the avoidance of oxides as a consequence of overheating would have to be constantly monitored. IN this regard, for example, the treated bar could be constantly removed, rewashed, and reinserted and recoated with mercury.

The phase two slurry is quite acidic with a pH level of between 3 and about 4. It also contains both hydrogen oxygen and chlorine atoms, probably in ionic form therein. The reason for this is that the phase one material has clathrate capabilities, i.e. can entrap or confine the hydrogen, oxygen and chlorine ions within the particles of the slurry.

While the aforesaid temperature gradients are important when forming the slurry preparatory to the subsequent formation of the complex, it should be noted that the slurry itself can also be formed using somewhat higher temperatures, on the order of up to about 40 degrees centigrade, and starting with aluminum of slightly less purity.

The next stage is the process of forming the final complex, i.e. stage three, is to adjust the pH so that the chlorine defined within the said particles of the slurry becomes active; “active” having meaning potentially unstable but not to the extent that the chlorine is liberated as chlorine gas. In this regard it is desirable that the pH level of the slurry ultimately reside at a pH of about 3.0±0.2. At this juncture, it could be noted that the viscosity of the slurry is between about 12,000 and 16,000 cps, the slurry will contain about 1.5 and about 3% aluminum suspended therein in elemental form.

The increase or decrease of the pH is accomplished by treating the phase two material with a strong hydroxide such as NaOH or KOH in case of increase and with HCl in case of decrease. The normality is not critical, but usually can be between about 2 and 3 Normal concentration. The increased or decreased pH slurry can be termed “phase three”. The slurry is now ready to be applied as a reactivator and transformer of the selected fly ash material to a flammable hydrocarbon containing oil.

“Phase four” consists of exposing fly ash to the emanation of the so treated and activated silicon containing aluminum in a closely controlled atmosphere during a period of between 24 hours and 48 hours as shown in FIG. 6.).

As shown a rod or bar of the treated silicon containing aluminum (1) is placed in a strong halogen-containing acidic solution; in an acid resistant container. The same container is then placed under a large open container containing the fly ash in loose condition (2). Over the air exposed fly ash is placed the activated-silicon aluminum complex in liquid aggregate state (3). The specific gravity of the said liquid complex is usually between 1.12 and 1.17, but slightly higher density is not detrimental. After the period of between 24 and 48 hours of exposure of the fly ash to the combined emanation of the strong halogen acid containing aluminum bar or rod (1) and the liquid form containing complex (3) a form of liquid hydrocarbon layer is deposited on the surface of the liquid complex. The same liquid hydrocarbon oil could be removed and placed in a suitable container and used for different industrial purposes such as light, heating or motor vehicle fuel.

This invention can be further illustrated by the following examples. Unless otherwise indicated all percentage are by weight:

### EXAMPLE 1

### Formation of the Slurry

500 grams of aluminum rod, having no more than about 0.1% impurities was placed in a 40 inch long glass vessel as exemplified by FIG. 1). At a temperature of 20° C. the aluminum was contacted with 3N hydrochloric acid in amounts sufficient to cover the aluminum rod. Thereafter the aluminum rod removed from the HCl bath and immersed in a mercury bath for approximately 20 seconds under moist (about 30% relative humidity) air-atmospheric conditions. There also being a layer of HCl covering the mercury bath. The mercury contacted aluminum rod was then re-immersed in a bath of 2N HCl. At this point the rod was positioned equidistant from the side and bottom of the vessel. A growth was observed on the immersed surface of the aluminum, on all sides thereof. The aluminum bar also begins to dissolve in the HCl bath.

Almost immediately a milky white cloud begins to appear. After about seven hours a slurry begins to be discernible. The temperature was kept below 30° C. The reaction continued until all the aluminum bar was consumed. Before the bar was consumed, however, the slurry became so thick the reaction was severely inhibited. This occurred after about 48 hours. This thick slurry was then removed and fresh HCl added. This was continued until the dissolution of the aluminum was completed. The pH of the slurry was then adjusted to 3.0±0.2 by increasing the hydrogen ion content by addition of HCl.

### EXAMPLE 2

### Application of the Slurry

An amount of about 5 kg. of fly ash is spread out on a shallow vessel at room temperature. A 1 kg by weight treated and activated aluminum rod was placed underneath the fly ash containing vessel immersed in a 3N hydrochloric acid solution. ON the top of the fly ash containing vessel another vessel containing the activated-silicon containing aluminum complex in a controlled closed condition. After between 24 and 48 hours a distinctive smelling hydrocarbon-oil containing layer is developed. The same oil being removed and the operation continued.

### Utility as a Flammable Agent

The extent of utilizing this invention is enormous. Considering the huge amount of daily production of fly ash by different industries, it represents a huge ecological problem. Due to the inert status as a burning residue, it is used basically as a filler of surface depressions or as an additive in the production where it often plays a minor role. The cohesion of cement is often lessened by its presence. This invention, by reactivating and partially transforming the carbon skeleton into a flammable, industrially usable hydrocarbon at relatively cheap production costs, does a great service to the existing fly ash, creating industries by allowing them to recycle the part of the discarded and bothersome byproduct, and thus saving on production costs. Furthermore, it will lessen the burden of a huge ecological problem.

### Theoretical Explanation

In the patent Ser. Nos. 795,115 and 810,103, it is stated that the structure of aluminum can be changed by chemical and electrochemical attack. The cylindrical or spheroidal shape of the silicon trace was found to change to the hexagonal shape as a consequence of attack by the “free chlorine” of the slurry when such was applied to an ordinary aluminum foil. (U.S. Pat. No. 795,115). It is believed that the same change in structure occurs in the silicon particles contained in the aluminum particles suspended in the slurry due to the interaction of the mercury treated aluminum with the hydrochloric acid solution. This change in structure which can be observed in the finished oxygenated solid fuel (U.S. Pat. No. 810,103) is also believed to be significant, i.e. it furnishes some understanding of what has and does take place, which enables the subject composition to function as a hydrogen and oxygen delivery agent when it is exposed to a carbon based residue.

It should be noted that when ordinary aluminum is introduced into an HCL solution e.g. 1N or 2N, the production of aluminum chloride (and water) occurs. However, the mercury treated aluminum employed in this invention is quite a different creature. There is still the formation of AlCl₃, and other aluminum compounds as well, when such is immersed in the HCl solution. However, after the passage of from about 8 to 72 hours a slurry is formed starting as a faint white cloud. This is a consequence of a “growth” on the “treated” aluminum which growth then “falls off” or “flakes off” into the acid bath and begins to form the slurry. After a passage of about 8 hours or so, the slurry is in full “blom” and a discernible increase in viscosity begins to occur, leading if desired to a viscosity range of 12,000-16,000 cps.

In this slurry, a relatively small amount, weight wise of “activated” aluminum growth particles is suspended; perhaps as a colloid. As stated previously, the percentage of the same is between about 0.7 and 1.5% by weight. These “growth” particles, however, now contain entrapped therein because of their clathrate properties “free chlorine” (from the HCl)), oxygen and hydrogen probably in molecular or ionic form. The silicon of the aluminum has also been changed to the hexagonal structure.

Thus the slurry at least contains:
a) The reaction product of aluminum and hydrochloric acid in solution, e.g. Al***ClH* and OH ions.
b) Free “activated” aluminum suspended probably colloidally, containing hexagonally structured silicon and also additionally containing traces of chlorine, hydrogen and oxygen entrapped therein.

The unusual properties of the slurry may possibly also be explainable as a consequence of “Van der Waals forces” or the well known ability of particles in colloidal suspension to attract and retain on their surface dissolved substances and solvent molecules, i.e., to have molecules present in the solution even in ionic form become entrapped in or adhered on the particulate matter of the slurry or colloid. Whatever is the explanation, the slurry is a critical medium for the reactivation and enriching of the fly ash with the necessary hydrogen and oxygen in order to create a flammable and industrially usable hydrocarbon.

Although the present invention has been described with reference to particular embodiments and examples, it will be apparent to those skilled in the art that variations can be made.

What is claimed is:

1.) A composition for reactivating and partially transforming the carbon particles of the fly ash into a flammable hydrocarbon fuel from a slurry comprising activated-silicon containing aluminum particles prepared by the steps of
a) contacting aluminum metal containing at least trace amount of silicon with an acid of the type which will removed oxide coatings from and inhibit oxide formation thereon;
b) simultaneously or thereafter contacting said aluminum with mercury or a source of mercury;
c) immersing said mercury contacted aluminum metal in an acid bath at ambient temperature to not more than about 40° C., whereby particles are formed on the metal which on mixing with the acid bath form the slurry; and
d) adjusting the pH of the slurry to 3.0±0.2.

2.) The composition according to claim 1), wherein the acid of steps a) and c) is HCl.

3.) A method of reactivating and transforming the carbon particles of fly ash into a hydrocarbon fuel which comprises
a) Setting up a three stage apparatus which comprises a vessel containing fly ash, another vessel containing activated-silicon containing aluminum immersed in a strong HCl acid solution and placed under the fly ash containing vessel, and a third vessel placed on the top of the fly ash containing vessel which is the activated slurry previously mentioned.
b) Placing the mentioned apparatus of (a) in a controlled closed ambient at room temperature.
c) Removing after a period of between 24 hours and about 48 hours the formed hydrocarbon oil and placed in a suitable container.
